(19) United States
(12) Patent Application Publication
(10) Pub. No.: US 2007/0083844 A1
(43) Pub. Date: Apr. 12, 2007

(54) Logic circuit design support apparatus, and logic circuit design support method employing this apparatus

(76) Inventors: Chie Kabuo, Kyoto (JP); Yoko Shimada, Kyoto (JP); Kasumi Hamaguchi, Osaka (JP); Takashi Ishimura, Osaka (JP); Katsuya Fujimura, Kyoto (JP)

Correspondence Address: MCDERMOTT WILL & EMERY LLP, 600 13TH STREET, N.W., WASHINGTON, DC, 20005-3096, US

(21) Appl. No.: 11/542,272

(22) Filed: Oct. 4, 2006

(30) Foreign Application Priority Data
Oct. 6, 2005 (JP) P2005-293826

(51) Int. Cl. G06F 17/50

(52) U.S. Cl. 716/18

(57) ABSTRACT

A circuit structure analysis unit performs structure analysis for logic circuit information, obtained from an HDL description, and acquires analysis results for function parts, such as a register, an operation unit and a multiplexer. A synthesis instruction generation unit compares the analysis results with a synthesis instruction correlation rule, and automatically generates a synthesis instruction to control a logic synthesis method. Finally, an HDL description output unit outputs a synthesis instruction added HDL description, wherein a synthesis instruction is inserted into the original HDL description. When the synthesis instruction added HDL description is employed in the logic synthesis, starting at the top hierarchical level, a synthesis instruction for the logic circuit is not required in a synthesis execution script.

### BACKGROUND OF THE INVENTION

1. Field of the Invention

The present invention relates to a logic circuit design support apparatus that employs a hardware description language in the design of a logic circuit, and a logic circuit design support method that employs this apparatus.

2. Description of the Related Art

Conventionally, for designing a logic circuit, logic synthesis is performed. According to this method, based on design information at a register transfer level (hereinafter referred to as an RTL) in a hardware description language (hereinafter referred to as an HDL), such as VerilogHDL or VHDL, a gate level net list is generated that is optimized, depending on technology mapping, by employing, as objective functions, constraints, such as dimensions, timing and power consumption.

To perform logic synthesis, not only must there be entered constraints, such as dimensions, timing and power consumption, which are objectives for optimization, but also synthesis instructions, in order to designate how a circuit is to be handled that has currently been synthesized. These instructions are used, for example, to designate timing exceptions for paths, such as false paths, for which actual operations are not performed, to designate case analyses for identifying paths in test modes, or to designate hierarchical development.

A synthesis instruction is written as a script at the time logic synthesis is executed, and instance names or net names are employed in logic hierarchy. A script is a written guide on how to perform synthesization.

It should be noted that part of a synthesis instruction can be set by each module that constitutes a logic circuit, and for a logic synthesis tool currently available on the market, a setup of the constraints and attributes for the module can be written as a synthesis instruction for the tool by using comments in the HDL description. For example, in the logic synthesis tool “Design Compiler” produced by Synopsys Inc., although it is one example, it is possible that each module has an objective dimension (max area) as attribute, and it is possible to describe an instruction for that value by using comments in the HDL description.

As a method for a synthesis instruction to be included in the HDL description, proposed is a logic synthesis method for designating partial mapping for synthesizing a target portion using a form similar to a logic description (see, for example, patent document 1).

Here, the patent Document 1 indicates Japanese Patent No. 2,848,332 (Page 4, FIG. 2).

However, the target circuit scale for a logic synthesis tool is increasing year by year, and logic synthesis can now be performed for several millions to several tens of millions of gates. Thus, using the conventional method, wherein an instruction for a module at a lower level is written by using the script at the time logic synthesis is executed, the hierarchical name is extended and logic synthesis must be performed again, for either some of the setup will be missing or a setup error due to manual preparation will have occurred. As a result, the number of steps required for logic synthesis is increased.

Further, when a set consisting of an HDL description and a synthesis script are provided for IP use, and when the level of this set, reading from the top, is employed as a target for a collective synthesis, the net name and the instance name written in the original script must be changed to the hierarchical name read from the top. In this case, a manual preparation error may also occur. Further, the hierarchial name thus obtained is not very versatile, and each time the set is applied for IP use, the name must be changed.

Furthermore, in non-patent document 1, a compatible synthesis instruction in the HDL description is limited to a constraint for and an attribute of a module that is an objective. Since a synthesis instruction for the instance name or the net name in the module is written by using a script to be executed, the same problem is encountered as is described above.

In addition, in non-patent document 1 and in patent document 1, a compatible synthesis instruction in the HDL description is written manually, and does not suffice as a synthesis instruction when the characteristic of a synthesis instruction tool is taken into account. Since there is a case wherein a synthesis instruction is written after the results obtained by synthesis have been examined, again, the same problem is encountered as is described above.

### SUMMARY OF THE INVENTION

To resolve the conventional problem, one objective of the present invention is to simplify preparation of a synthesis script to be executed for large-scale collective synthesis, and to reduce the number of logic synthesis steps.

Another objective of the invention is to provide a logic circuit design support apparatus that increases multiplicity of use of HDL description and easily diverts the HDL description for design, and a method for employing this apparatus.

To achieve these objectives, a logic circuit design support apparatus and a method therefor have the following characteristics.

According to the present invention, a logic circuit design support apparatus, which employs an HDL description in which circuit information is written at a register transfer level, comprises:

an HDL description input unit, for receiving a first HDL description;

a circuit structure analysis unit, for analyzing types of function parts and connections of the function parts based on the circuit information;

a synthesis instruction generation unit, for employing the analysis results to generate a synthesis instruction for a designated logic synthesis tool; and

a synthesis instruction added HDL description output unit, for outputting a second HDL description obtained by adding the synthesis instruction to the first HDL description. With this arrangement, since the synthesis instruction is generated based on the circuit structure and is provided for the HDL description, preparation of the synthesis script can be simplified for a large-scale collective synthesization process, and the number of logic synthesis steps can be reduced. Further, the thus output HDL description with the added synthesis instruction can be easily applied for a variety of designs.

Furthermore, the logic circuit design support apparatus further comprises:

a synthesis instruction correlation rule storage unit, for storing a rule for correlating, with a characteristic of a circuit structure, a synthesis instruction method for a designated logic synthesis tool,

wherein the synthesis instruction generation unit refers to the synthesis instruction correlation rule.

The logic circuit design support apparatus of the invention further comprises:

a display unit, for displaying a synthesis instruction generated by the synthesis instruction generation unit;

an external input unit, for manually, establishing an adoption of a synthesis instruction and additionally entering the synthesis instruction; and

a synthesis instruction setup unit, for correlating the established synthesis instruction with a description location in the first HDL description.

The logic circuit design support apparatus of the invention further comprises:

a synthesis instruction optimization unit, for selecting an optimal synthesis instruction from either the synthesis instruction, written in the first HDL description, or the synthesis instruction, generated by the synthesis instruction generation unit. With this arrangement, when the second, previously prepared HDL description is changed, or when alteration of a synthesis instruction is required because the specification for a logic synthesis tool to be employed is changed, switching to the optical synthesis instruction can be easily performed.

Furthermore, according to the invention, a logic circuit design support apparatus, which employs an HDL description in which is written circuit information at a register transfer level, comprises:

an HDL description input unit, for receiving a first HDL description;

a function verification unit, for employing the circuit information to detect a false path for a circuit operation; and

a synthesis instruction added HDL description output unit, for outputting a second HDL description obtained by adding information for the false path to the first HDL description. With this arrangement, information for a false path in a target module can be included in the HDL description, a timing constraint can be easily prepared for a large-scale collective synthesis process, and the number of logic synthesis steps can be reduced.

In addition, according to the invention, a logic circuit design support apparatus, which employs an HDL description in which is written circuit information at a register transfer level, comprises:

an HDL description input unit, for receiving a first HDL description;

a synthesis instruction input unit, for receiving a synthesis instruction, relative to the first HDL description, included in a logic synthesis tool execution script;

a synthesis instruction allocation unit, for correlating the first HDL description with the synthesis instruction; and

a synthesis instruction added HDL description output unit, for outputting a second HDL description obtained by adding the synthesis instruction to the first HDL description. With this arrangement, when the IP or the HDL description output by an RTL generation tool is included, a script wherein an individual constraint is written need not be employed, and during the performance of the large-scale collective synthesis process, preparation of a script can be easily performed.

According to the present invention, a logic circuit design support method, for employing an HDL description in which is written circuit information at a register transfer level, comprises:

an HDL description input step of receiving a first HDL description;

a circuit structure analysis step of analyzing types of function parts and connections of the function parts based on the circuit information;

a synthesis instruction generation step of employing the analysis results to generate a synthesis instruction for a designated logic synthesis tool;

a synthesis instruction setup step of manually, establishing an adoption of a synthesis instruction and additionally entering the synthesis instruction, and of correlating the established synthesis instruction with a description location in the first HDL description; and

a synthesis instruction added HDL description output step of outputting a second HDL description obtained by adding the synthesis instruction to the first HDL description. With this arrangement, since the synthesis instruction is generated based on the circuit structure and is provided for the HDL description, preparation of the synthesis script can be simplified for a large-scale collective synthesization process, and the number of logic synthesis steps can be reduced. Further, the thus output HDL description with the added synthesis instruction can be easily applied for a variety of designs.

The logic circuit design support method of the invention further comprises:

a synthesis instruction optimization step of selecting an optimal synthesis instruction from either the synthesis instruction, written in the first HDL description, or the synthesis instruction, generated at the synthesis instruction generation step. With this arrangement, when the second, previously prepared HDL description is changed, or when alteration of a synthesis instruction is required because the specification for a logic synthesis tool to be employed is changed, switching to the optical synthesis instruction can be easily performed.

Furthermore, according to the invention, a logic circuit design support method, for employing an HDL description in which is written circuit information at a register transfer level, comprises:

an HDL description input step of receiving a first HDL description;

a function verification step of employing the circuit information to detect a false path for a circuit operation; and

a synthesis instruction added HDL description output step of outputting a second HDL description obtained by adding information for the false path to the first HDL description. With this arrangement, information for a false path in a target module can be included in the HDL description, a timing constraint can be easily prepared for a large-scale collective synthesis process, and the number of logic synthesis steps can be reduced.

In addition, according to the invention, a logic circuit design support method, for employing an HDL description in which is written circuit information at a register transfer level, comprises:

an HDL description input step of receiving a first HDL description;

a synthesis instruction input step of receiving a synthesis instruction, relative to the first HDL description, included in a logic synthesis tool execution script;

a synthesis instruction allocation step of correlating the first HDL description with the synthesis instruction; and

a synthesis instruction added HDL description output step of outputting a second HDL description obtained by adding the synthesis instruction to the first HDL description. With this arrangement, when the IP or the HDL description output by an RTL generation tool is included, a script wherein an individual constraint is written need not be employed, and during the performance of the large-scale collective synthesis process, preparation of a script can be easily performed.

Furthermore, according to the logic circuit design support method, at the synthesis instruction added HDL description output step, conditional branching of the HDL description employing a macro variable written in VerilogHDL is output. With this arrangement, even for a circuit wherein a problem occurs for a circuit operation under a specific condition, logic that prevents this problem is automatically inserted in the HDL description. Thus, this problem need not be taken into account during the RTL design process.

Further, for the logic circuit design support method of the invention, at the synthesis instruction generation step, when a conditional branch using a macro variable is included in the first HDL description, a macro variable value is determined based on circuit structure analysis results, and at the synthesis instruction added HDL description output step, a description for setting the value of the macro variable is added to the second HDL description. With this arrangement, the macro variable can be designated based on the structure analysis, and an instruction can be easily issued for logic synthesis.

Furthermore, for the logic circuit design support method, the synthesis instruction added HDL description output step includes the steps of: designating an output in an extensible language;

allocating a conversion rule extracted between a synthesis instruction and a description method in the extensible language for a synthesis instruction; and outputting a second HDL description in the extensible language. With this arrangement, the tool dependency of a synthesis instruction added HDL description to be output can be reduced, and the HDL description can be employed for various other purposes.

Moreover, according to the invention, for the logic circuit design support method, for employing an HDL description in which circuit information is written at a register transfer level, the HDL description includes:

a synthesis instruction relative to a module; and

a synthesis instruction relative to an instance that is a module at a lower level. With this arrangement, a flexible instruction can be issued when the same module is employed as a plurality of instances.

In addition, according to the invention, provided is a logic circuit design support method, wherein logic synthesis is performed employing an HDL description, in which circuit information is written at a register transfer level, and a logic library, and wherein designation of a cell for inhibiting an allocation in the logic library is enabled relative to individual modules in a logic hierarchy. With this arrangement, only collective synthesis from the top must be performed, and resynthezation of individual modules is not required. As a result, the number of logic synthesis steps can be reduced.

Furthermore, according to the invention, a logic circuit design support method is provided wherein, based on a plurality of evaluation values, logic synthesis is performed by employing an HDL description, in which circuit information at a register transfer level is written, and a logic library, and wherein priority ranks for the evaluation values are designated for individual modules in a logic hierarchy. With this arrangement, only collective synthesization from the top must be performed, so that an optimization method can be employed that is consonant with the characteristic of the circuit.

Further, according to the invention, provided is a logic circuit design support method, wherein logic synthesis is performed by employing an HDL description, in which circuit information at a register transfer level is written, and a logic library; and wherein the HDL description is a synthesis instruction added HDL description that includes a logic optimization inhibition instruction relative to a wire-declared signal name. With this arrangement, logic optimization can be prevented between a fault observation point and a selector consonant by using a test mode signal, and a desired fault detection rate can be maintained.

Also, according to the invention, provided is a logic circuit design support method, wherein logic synthesis is performed by employing an HDL description, in which circuit information is written at a register transfer level, and a logic library; and wherein the HDL description is a synthesis instruction added HDL description that designates an instance name for of a selector cell relative to a case sentence or an if sentence. With this arrangement, when the instance name is received for a cell that is mapped as a selector, a constraint for a selector, relative to a test circuit, can be easily designated. Further, a cell need not directly be designated as an instance, and the HDL description can be used in many more ways.

According to the logic circuit design support apparatus of the invention, a synthesis instruction for a designated logic synthesis tool is generated based on the structure analysis or function verification in accordance with the HDL description of the RTL, and is output as an HDL description to which a synthesis instruction has been added. Further, when an output in an extensible language is designated, conversion of a synthesis instruction into an extensible language is performed. Further, when, like the IP, a pair consisting of an HDL description and a synthesis script is provided, a synthesis instruction included in a synthesis script is inserted in the HDL description. In addition, an HDL description with an added, previously generated synthesis instruction is changed into an optimal synthesis instruction.

Therefore, a synthesis instruction added HDL description that is output can be easily applied for a design process, and also, another type of design process that employs this HDL description can be efficiently performed.

Furthermore, the logic circuit design support apparatus of the invention performs logic synthesis by accepting the individual synthesis instruction added HDL descriptions that have been output.

Therefore, the preparation of a synthesis script can be easily performed during the large-scale collective synthesis processing, and the number of logic synthesis steps can be reduced.

In addition, according to the logic circuit design support method of the invention, as synthesis instructions, an optimization preference and an allocation inhibition cell designation can be generated for individual modules.

Therefore, collective synthesis from a top hierarchical level can be performed, and the number of logic synthesis steps can be reduced.

Further, according to the logic circuit design support method of the invention, the designation of the instance name of a selector and the designation of an optimization inhibition net can be generated as synthesis instructions.

Therefore, a constraint for selector logic can be easily designated for a test circuit, and a desired fault detection rate can be maintained.

Also, according to the logic circuit design support method of the invention, conditional branching of an HDL description using a macro variable can be generated based on the structure analysis, and the value of a macro variable can be designated.

Therefore, for a circuit wherein a circuit operation problem occurs when a specific condition is encountered, this must be taken into consideration during the RTL design process and during the logic synthesis process.

### BRIEF DESCRIPTION OF THE DRAWINGS

FIG. 1 is a block diagram showing a logic circuit design support apparatus according to a first embodiment of the present invention.

FIG. 2 is a flowchart for a logic circuit design support method according to the first embodiment.

FIG. 3 is a detailed flowchart showing the HDL description output process.

FIGS. 4(a) and 4(b) are diagrams showing example synthesis instruction added HDL descriptions.

FIGS. 5(a), 5(b), 5(c) and 5(d) are diagrams showing example synthesis instruction added HDL descriptions.

FIG. 6 is a diagram showing an example synthesis instruction added HDL description.

FIG. 7 is a block diagram showing a logic circuit design support apparatus according to a second embodiment of the present invention.

FIG. 8 is a flowchart for a logic circuit design support method according to the second embodiment.

FIG. 9 is a block diagram showing a logic circuit design support apparatus according to a third embodiment of the present invention.

FIG. 10 is a flowchart for a logic circuit design support method according to the third embodiment.

FIG. 11 is a block diagram showing a logic circuit design support apparatus according to a fourth embodiment of the present invention.

FIG. 12 is a flowchart for a logic circuit design support method according to the fourth embodiment.

FIGS. 13(a) and 13(b) are diagrams showing example HDL descriptions to which an allocation inhibition cell instruction is added.

FIGS. 14(a) and 14(b) are diagrams showing example HDL descriptions to which an optimization priority level instruction is added.

FIGS. 15(a) and 15(b) are diagrams showing example HDL descriptions to which a wire logic optimization inhibition instruction is added.

FIGS. 16(a) and 16(b) are diagrams showing example HDL descriptions to which an instance name instruction for a selector cell is added.

FIG. 17 is a block diagram showing a logic circuit design support apparatus according to a fifth embodiment of the present invention.

FIG. 18 is a flowchart for a logic circuit design support method according to the fifth embodiment.

### DESCRIPTION OF THE PREFERRED EMBODIMENTS

The preferred embodiments of the present invention will now be described in detail while referring to the accompanying drawings.

(First Embodiment)

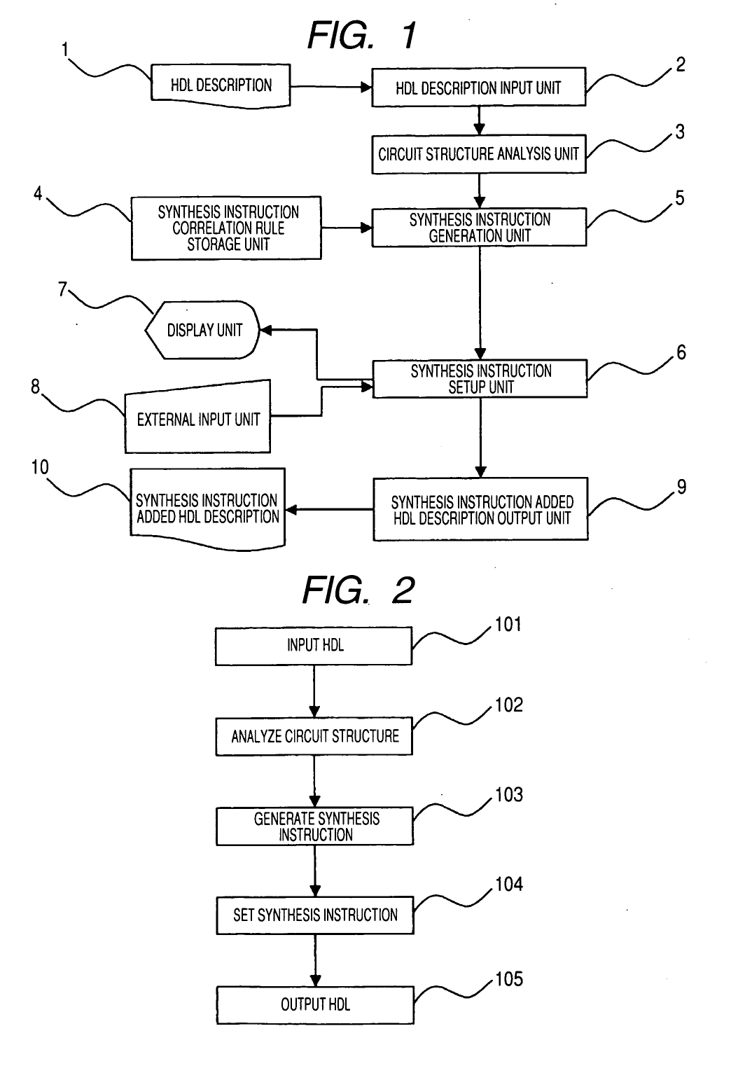

FIG. 1 is a block diagram showing the configuration of a logic circuit design support apparatus according to a first embodiment of the present invention. As shown in FIG. 1, the logic circuit design support apparatus includes: an HDL description input unit 2, for receiving an HDL description 1, in which circuit information for an RTL is written; a circuit structure analysis unit 3, which analyzes the circuit structure based on the circuit information included in the HDL description that is received; a synthesis instruction generation unit 5, which synthesizes the characteristic of the circuit structure, obtained by the circuit structure analysis unit 3 through an analysis of the circuit structure, and a synthesis instruction correlation rule, obtained from a synthesis instruction correlation rule storage unit 4 in which correlation rules are stored that are correlated with synthesis instruction methods for designated logic synthesis tools; a synthesis instruction setup unit 6, which designates for display a synthesis instruction generated by the synthesis instruction generation unit 5; a display unit 7, which displays the generated synthesis instruction; an external input unit 8, which is used manually to establish the adoption of a synthesis instruction, and additionally, to enter the synthesis instruction; and a synthesis instruction added HDL description output unit 9, which outputs synthesis instruction added HDL description 10, for which the synthesis instruction is additionally provided.

FIG. 2 is a flowchart showing a logic circuit design support method employed by the logic circuit design support apparatus of the first embodiment. While referring to FIG. 2, and in consonance with the configuration shown in FIG. 1, the operation of the logic circuit design support apparatus of this embodiment will be explained.

First, at step 101, the HDL description input unit 2 receives the RTL circuit information written in the HDL description 1. At step 102, based on the circuit information, the circuit structure analysis unit 3 prepares connection information formed of function parts, such as a register, an operation unit and a multiplexer, that are components of an RTL logic circuit, and generates the analysis results that include the types of function parts, the connection relationship and the number of logical stages.

At step 103, the synthesis instruction generation unit 5 correlates the logic circuit analysis results with a synthesis instruction correlation rule that is stored in the synthesis instruction correlation rule storage unit 4. At step 104, the synthesis instruction setup unit 6 displays the generated synthesis instruction on the display unit 7. The adoption of a synthesis instruction is established, manually, through the external input unit 8, and the synthesis instruction is additionally entered. Then, the established synthesis instruction is correlated with the description location in the HDL description 1. At step 105, the synthesis instruction added HDL description output unit 9 outputs the synthesis instruction added HDL description 10 for which the synthesis instruction is additionally provided.

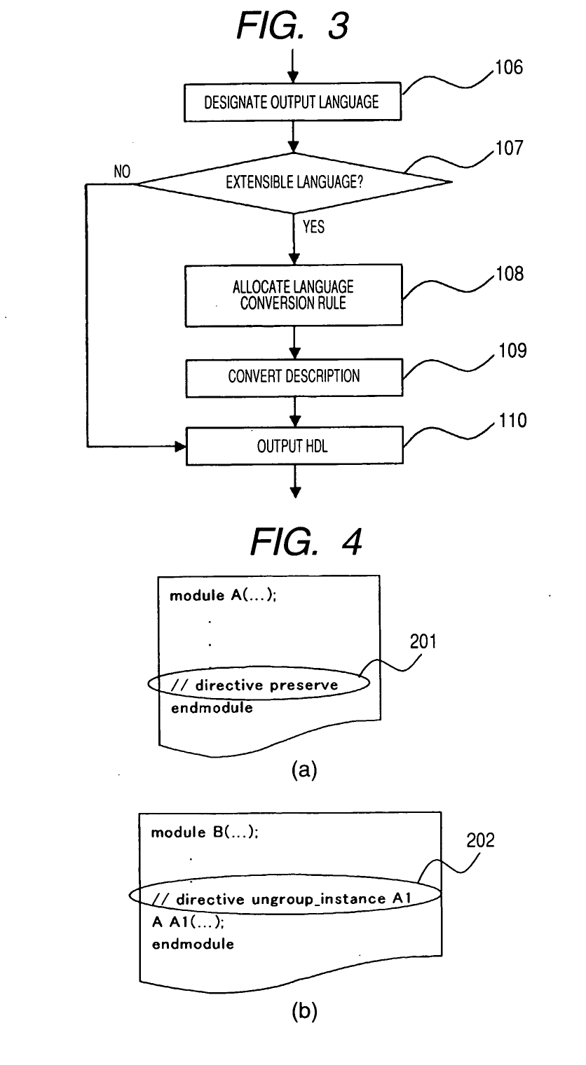

FIG. 3 is a detailed flowchart showing the operation of the synthesis instruction added HDL description output unit 9 in FIG. 1. At step 106 in FIG. 3, a language type to be output is designated, and at step 107, a check is performed to determine whether the designated language is an extensible language. When SystemVerilog is designated as an output language, this is determined to be the VerilogHDL extensible language. When the designated language is not an extensible language, program control advances to step 110 and an HDL description is output wherein a synthesis instruction is added as a comment. When an extensible language is designated, at step 108, the designated synthesis instruction is compared with a language conversion rule for converting the synthesis instruction into a language description. When conversion is enabled, at step 109, conversion of the description is performed, and at step 110, the HDL description is output in the designated language.

Examples for synthesis instruction added HDL descriptions, which are output by the synthesis instruction added HDL description output unit 9, are shown while referring to FIGS. 4 to 6.

FIGS. 4(a) and 4(b) are diagrams showing example synthesis instruction added HDL descriptions that are output by the synthesis instruction added HDL description output unit 9. In FIG. 4(a), an HDL description for a module A is shown, and in FIG. 4(b), an HDL description is shown for a module B that includes the module A as an instance A1. In FIGS. 4(a) and 4(b), each of the comments 201 and 202 indicate a synthesis instruction added to the original HDL description. In this case, according to the synthesis instruction 201, the retention of a hierarchy is instructed for the module A, and according to the synthesis instruction 202, the development of the hierarchy for the instance A1 is instructed for the module B. As described above, when an instruction for a module and an instruction for an instance of the module conflict, in the logic synthesis process, the instruction for the instance is employed prior to the other.

The synthesis instruction 201 in FIG. 4(a), for instructing the retention of the hierarchy, and the synthesis instruction 202 in FIG. 4(b), for instructing the development of the hierarchy, may be generated based on the analysis results obtained by the circuit structure analysis unit 3 and the synthesis instruction correlation rule 4, or may be manually entered via the external input unit 8. An example instruction, which is generated based on the analysis results obtained by the circuit structure analysis unit 3 and the synthesis instruction correlation rule 4, can be an instruction to the effect that, “when an input/output ports, but not a clock or a set or reset signal port, are directly connected to registers, the retention of the hierarchy should be performed during the logic synthesis process”.

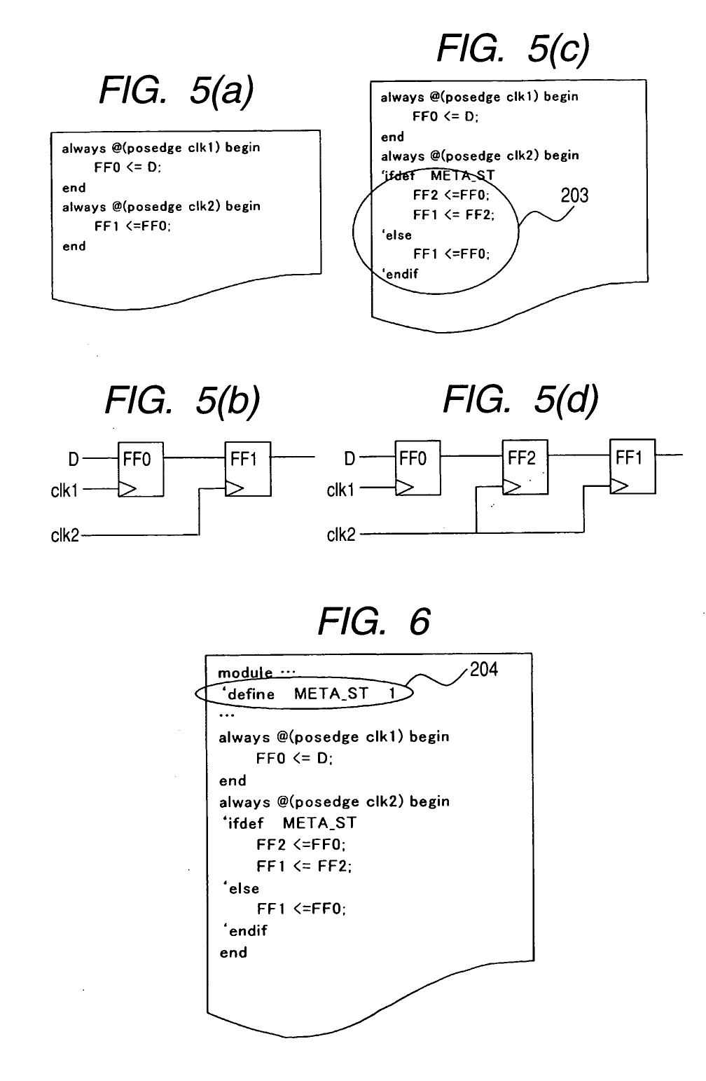

An example shown in FIGS. 5(a) to 5(d) will now be explained.

An input HDL description is shown FIG. 5(a), and a logic circuit represented by the HDL description in FIG. 5(a) is shown in FIG. 5(b). A synthesis instruction added HDL description, output by the synthesis instruction added HDL description output unit 9, is shown in FIG. 5(c). And a circuit is shown in FIG. 5(d) wherein “1” is the value of a macro variable META_ST 203 in the HDL description in FIG. 5(c). When the value of META_ST is 0, the circuit shown in FIG. 5(b) is employed. The path extending from flip-flop FF0 to flip-flip FF1 in FIG. 5(a) is an asynchronous path between different clocks, and there is a probability that an unstable state of the flip-flops, called a metastable state, will occur. One method for avoiding this state is a circuit shown in FIG. 5(d), wherein the state of the flip-flips is stabilized by providing an additional flip-flip. It should be noted, however, that the metastable state occurs when a timing constraint for the setup or the holding of the flip-flips is not satisfied. When there is a remaining margin in the timing, the circuit in FIG. 5(b) is sufficient.

Alteration of the HDL description in FIG. 5(a) to the HDL description FIG. 5(c) is performed by conforming to the synthesis instruction correlation rule that, based on analysis results indicating that an inter-register path between different clocks was detected by the circuit structure analysis unit 3, the HDL description should be changed to an HDL description that includes a macro variable META_ST.

FIG. 6 is a diagram showing a synthesis instruction added HDL description that includes a synthesis instruction 204 that designates the value of the macro variable META_ST in FIG. 5(c). To obtain this description, the HDL description in FIG. 5(c) is entered, and the analysis results that are received indicate the circuit structure analysis unit 3 detected that the macro variable META_ST is included. Then, during the process explained at step 104 in FIG. 2, the synthesis instruction setup unit 6 requests the entry time timings for the cycles of two clocks from of the external input unit 8, and when the minimum interval between the rising edges of the two clocks is equal to or smaller than a predetermined value, 1 is designated for the macro variable META_ST, whereas if the minimum interval is greater than the predetermined value, 0 is designated. The value of the macro variable may be designated directly by the external input unit 8.

As described above, since the logic circuit design support apparatus includes: the circuit structure analysis unit 3, for analyzing, as a target, the HDL description at the RTL, the synthesis instruction generation unit 5, for employing the analysis results to generate a synthesis instruction relative to a designated logic synthesis tool, and a synthesis instruction added HDL description output unit 9, for outputting an HDL description, for which a synthesis instruction is additionally provided, the synthesis script preparation can be easily performed during the large-scale collective synthesis processing. Further, the synthesis instruction added HDL description that is output can be easily applied for a variety of designs.

(Second Embodiment)

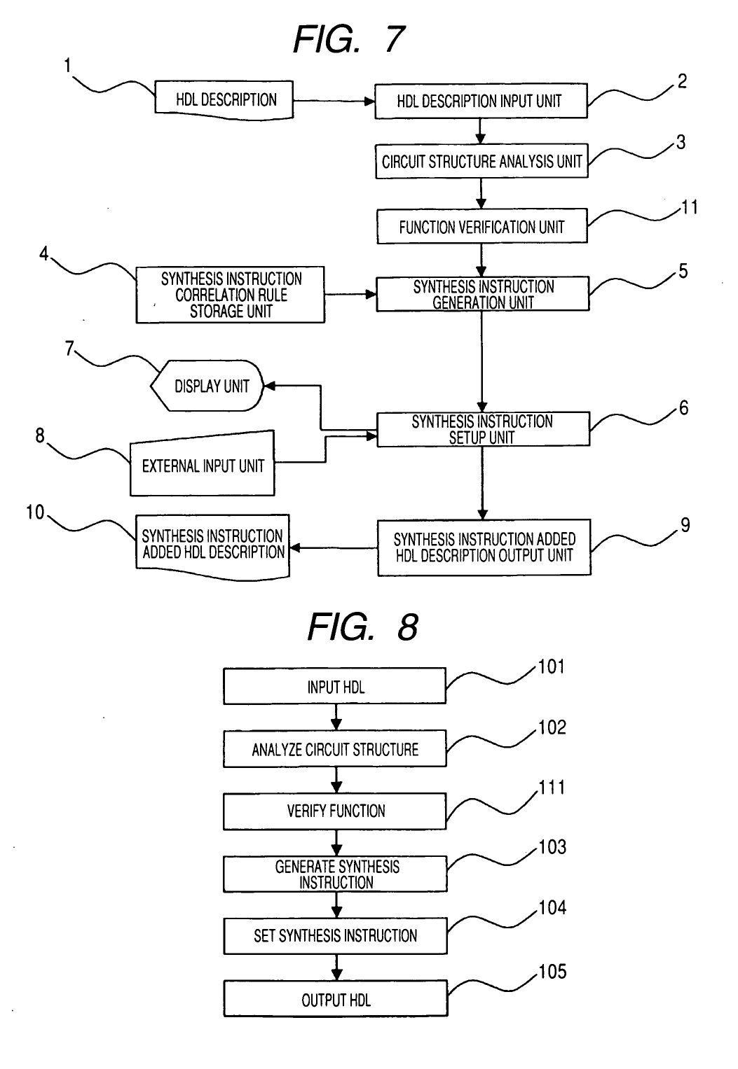

FIG. 7 is a block diagram showing the configuration of a logic circuit design support apparatus according to a second embodiment of the invention. FIG. 8 is a flowchart for the logic circuit design support apparatus and a method therefor according to this embodiment.

The characteristic of this embodiment is that a circuit structure analysis unit 3 analyzes a circuit structure and thereafter performs a verification function. In FIG. 7, components 1 to 10 are the same as those in FIG. 1 for the first embodiment, and the only difference is that a function verification unit 11 is provided.

In FIG. 8, the processes at steps 101 to 102 and at steps 103 to 105 are performed in the same manner as they are in FIG. 2 for the first embodiment.

The process performed by the function verification unit 11 at step 111 will now be described.

A conventional, formal verification technique is employed as a function verification method, and the following two methods are performed for the detection of a false path.

One method involves verification based on the circuit specification. According to this method, a set of values that are actually impossible is designated for two or more selector control signals, and an inter-register path that can be connected at this time is defined as a false path.

When, for example, a specification is designated that “control signals s1 and s2 do not have the same value at the same time”, an inter-register path that is connected at the time s1=s2=1, or s1=s2=0 is designated a false path.

The other method is the opposite of this one. That is, relative to a path that is detected by the circuit structure analysis unit 3 and is located at a large number of logic stages, a value for a control signal is obtained when a selector on that path is connected. Then, verification is performed to determine whether the value is available for all the individual control signals at the same time. When the result is false, the path is defined as a false path.

As a result, at step 105 in FIG. 8, the information thus detected for the false path is added to the HDL description by employing “set_false_path”, which is a false path setup command in a design constraint format.

As described above, since the function verification unit 11, for employing circuit information to detect a false path in a circuit operation, is provided, the information for a false path in a target circuit can be included in the HDL description, and preparation of the timing constraint can be easily performed during the large-scale collective synthesis process.

(Third Embodiment)

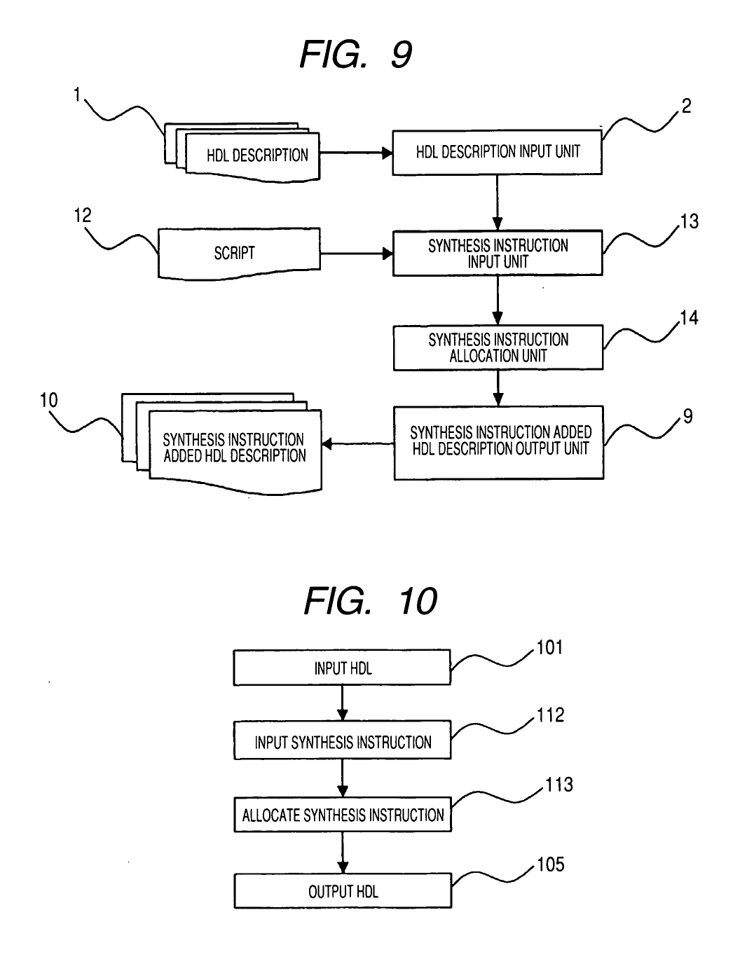

FIG. 9 is a block diagram showing the configuration of a logic circuit design support apparatus according to a third embodiment of the present invention, and FIG. 10 is a flowchart for the logic circuit design support apparatus, and a method therefor, according to this embodiment. The characteristic of this embodiment is that an instruction for synthesizing HDL and IP, i.e., a script 12, is entered by a synthesis instruction input unit 13, and a synthesis instruction in the script 12 is allocated to a portion in an HDL description 1 by a synthesis instruction allocation unit 14.

In FIG. 9, the synthesis instruction input unit 13 receives the script 12, which is for the execution of logic synthesis for the HDL description 1, and the synthesis instruction allocation unit 14 allocates a synthesis instruction, in the script 12, for the portion in the HDL description 1.

While referring to FIG. 10, the operation of the logic circuit design support apparatus of this embodiment will be described in correlation with the configuration in FIG. 9.

In FIG. 10, the process at step 101, for entering an HDL description, and the process at step 105, for outputting a synthesis instruction added HDL description, are performed in the same manner as are those in FIG. 2 for the first embodiment. At step 112, the synthesis instruction input unit 13 receives the script 12 for the circuit and extracts a synthesis instruction. At step 113, the synthesis instruction allocation unit 14 determines whether the extracted synthesis instruction is for the entire circuit or for a specified instance or signal, and correlates the synthesis instruction with the input HDL description 1.

Thereafter, the process at step 105 is performed for the correlated synthesis instruction.

As described above, the logic circuit design support apparatus includes the synthesis instruction input unit 13, which receives the logic synthesis execution script 12 that is relative to the HDL description 1 and that extracts a synthesis instruction, and the synthesis instruction allocation unit 14, which correlates the HDL description with the synthesis instruction. Therefore, even when the IP or the HDL description output by the RTL generation tool is included, preparation of the script during the large-scale collective synthesis process can be easily performed, without having to employ the script wherein individual constraints are written.

(Fourth Embodiment)

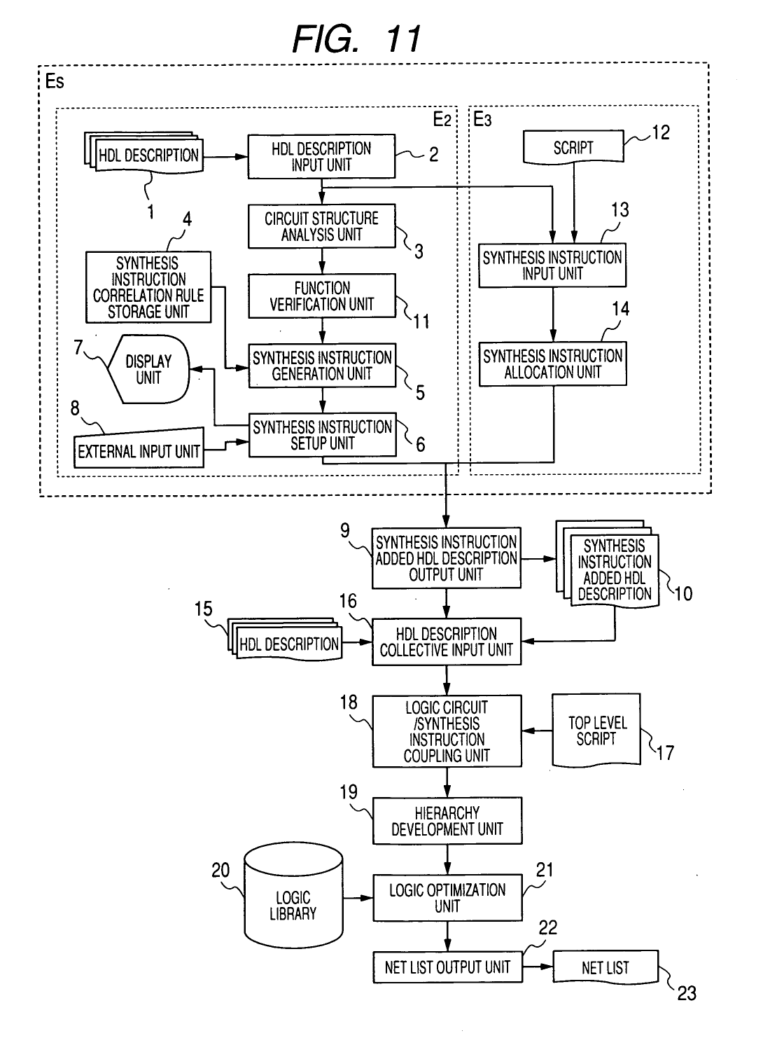

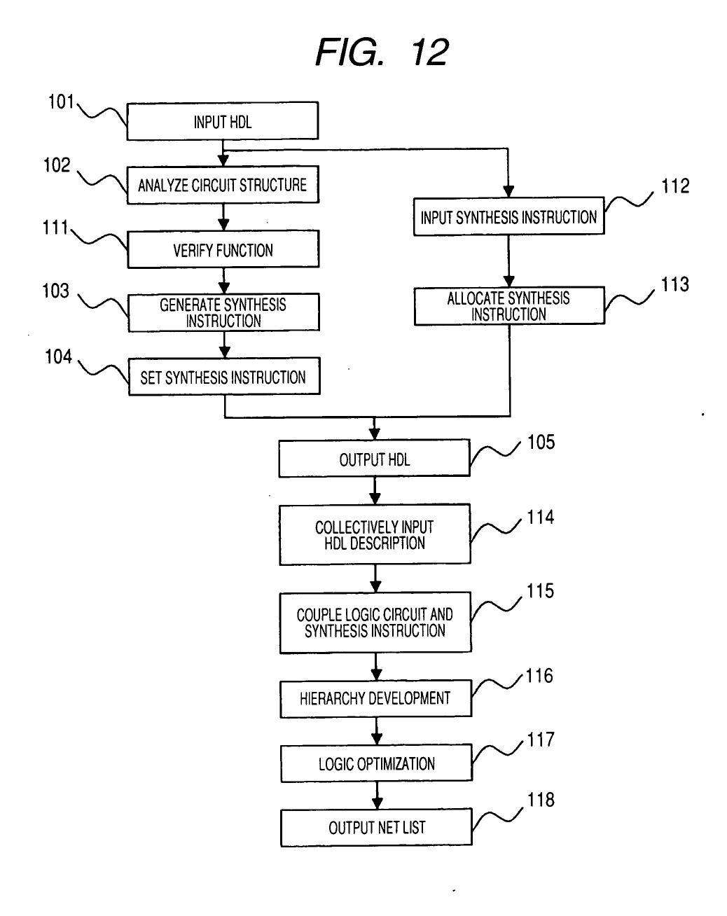

FIG. 11 is a block diagram showing the configuration of a logic circuit design support apparatus according to a fourth embodiment of the present invention, and FIG. 12 is a flowchart for the logic circuit design support apparatus of this embodiment and a method therefor.

In FIG. 11, the components for which the same reference numerals as in FIG. 1, 7 or 9 are provided have the same functions as in the above embodiments.

In this embodiment, as shown in the block diagram in FIG. 11, the logic circuit design support apparatus includes: a circuit structure analysis unit 3, which analyzes, as an target, an HDL description at an RTL; a synthesis instruction generation unit 5, which employs the obtained analysis results to generate a synthesis instruction relative to a designated logic synthesis tool; a synthesis instruction setup unit 6, which designates the generated synthesis instruction; a synthesis instruction input unit 13, which receives a logic synthesis execution script 12, relative to the HDL description 1, and extracts a synthesis instruction; and a synthesis instruction allocation unit 14, which correlates the HDL description with a synthesis instruction. When a synthesis instruction added HDL description output unit 9 has obtained a synthesis instruction added HDL description 10, the logic synthesis process is performed. That is, the HDL description at a level, such as the top level, whereat a synthesis instruction added HDL description is not generated is added to the synthesis instruction added HDL description 10.

Specifically, means Es, enclosed by the broken line in FIG. 11 is constituted by means E2, which has been explained in the second embodiment, and means E3, which has been explained in the third embodiment. Therefore, in this embodiment, an HDL description at a level, such as the top level, whereat a synthesis instruction added HDL description is not generated is collectively entered by an HDL description collective input means 16, which is located downstream of the means Es. Furthermore, farther downstream, a hierarchy development unit 19 performs a hierarchical development, a logic optimization unit 21 performs optimization, and a net list output unit 22 outputs a net list 23.

Referring to FIG. 11, also provided are: HDL descriptions 15, at a level, such as a top level, whereat a synthesis instruction added HDL description is not generated; the HDL description collective input unit 16, into which are entered all the HDL descriptions for a logic circuit that is a target for logic synthesis; a script 17, at the top level, for executing a logic synthesis tool; a logic circuit/logic synthesis coupling unit 18; the hierarchy development unit 19; a logic library 20; the logic optimization unit 21; the net list output unit 22; and the net list 23.

While referring to FIG. 12, the operation of the logic circuit design support apparatus of this embodiment will now be explained in correlation with the configuration in FIG. 11.

When an HDL description and a synthesis script are provided as a pair, like IP, for a target logic circuit for logic synthesis, at steps 112 and 113 the synthesis instruction added HDL description 10 is generated in the same manner as in the third embodiment. For the other logic circuit, at steps 102 to 104 the synthesis instruction added HDL description 10 is generated in the same manner as in the first and the second embodiments.

At step 114, for outputting the HDL description, the HDL description collective input unit 16 receives the synthesis instruction added HDL description 10 and the HDL description 15 at the top level.

At step 115, the logic circuit/synthesis instruction coupling unit 18 receives a synthesis script 17 at the top level, and couples the individual modules in the hierarchical structure with the synthesis instruction. That is, for each module, descending from the top, the logic hierarchy includes a hierarchical name, and the synthesis instruction written in the synthesis instruction added HDL description is changed to the setup relative to the hierarchical name.

At step 116, the hierarchy development unit 19 performs the hierarchical development in accordance with the hierarchy instruction. Then, at step 117, the logic optimization unit 21 employs the logic library 20 to perform technology mapping, so that design constraints, such as dimensions, timing and power consumption, are satisfied. Finally, at step 118, the net list output unit 22 outputs the net list 23 for the entire target net list.

An explanation will now be given for an example synthesis instruction added HDL description 10 of this embodiment, and a logic synthesis method performed in accordance with the synthesis instruction.

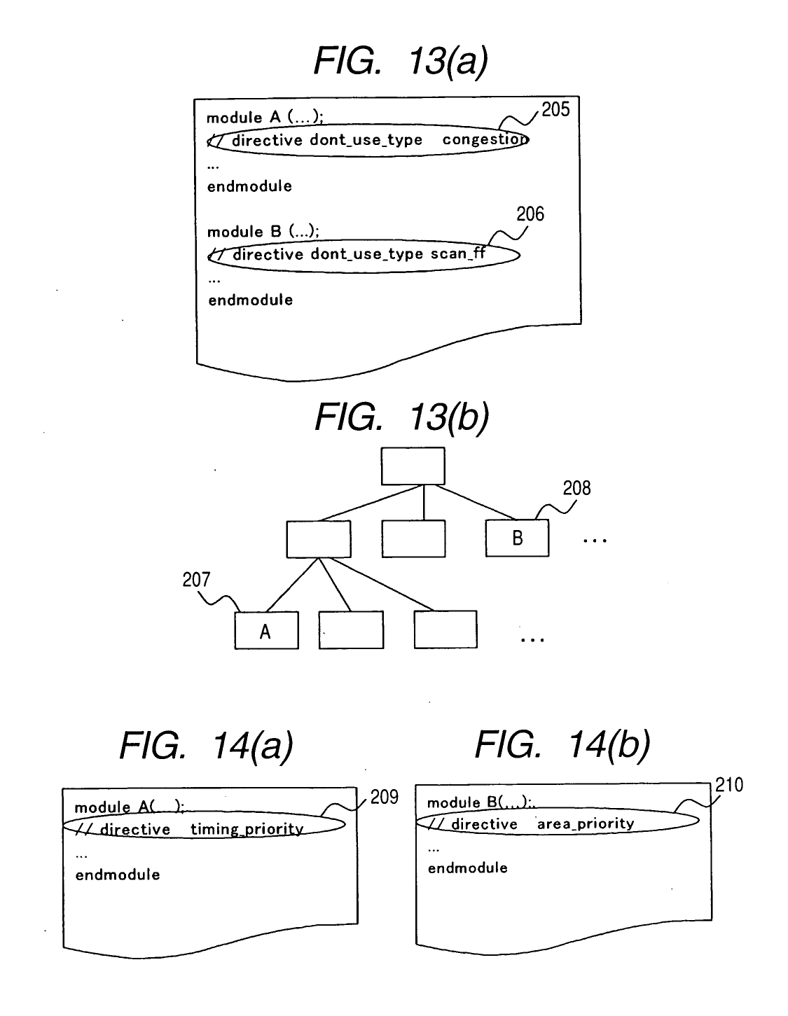

An example HDL description for which an allocation inhibited cell instruction is additionally provided is shown in FIG. 13(a). FIG. 13(b) is a diagram showing the hierarchial structure of a target logic circuit for logic synthesis. Assume that module A and module B, written in FIG. 13(a), are located at positions 207 and 208 in the hierarchial structure in FIG. 13(b). A synthesis instruction 205 in FIG. 13(a) designates, for the module A, the inhibition of the use of a cell related to wiring congestion, and a synthesis instruction 206 designates, for the module B, the inhibition for the user of a scan flip-flop. When the thus designated modules A and B are included in the hierarchy development process at step 116, the modules A and B are hierarchically retained, and at step 117, before logic optimization is performed, the cell in the logic library 20 for which use is inhibited is set for each module. The inhibition for the use of the cell related to wiring congestion is the inhibition of the use of a multi-input logic gate or a compound gate.

FIGS. 14(a) and 14(b) are diagrams showing examples of the HDL descriptions in which optimization priority levels are included. In FIG. 14(a), a synthesis instruction 209 designates a timing priority for the module A, and in FIG. 14(b), a synthesis instruction 210 designates a dimension priority for the module B. In these examples, assume that modules A and B are located at positions 207 and 208 in the hierarchical structure in FIG. 13(b). When the thus designated modules A and B are included in the hierarchical development process at step 116, the modules A and B are hierarchically retained. And at step 117, the circuit structure is generated in accordance with the individual priority levels and logic optimization is performed. When the timing priority or the dimension priority is to be included in the synthesis instruction, an estimate of the number of logic stages in the circuit structure analysis at step 102, for example, can be employed. That is, the timing priority can be designated for a module that has many paths, each of which have a large number of logic stages, and the dimension priority can be designated for a module that has, as a whole, paths having a small number of logic stages.

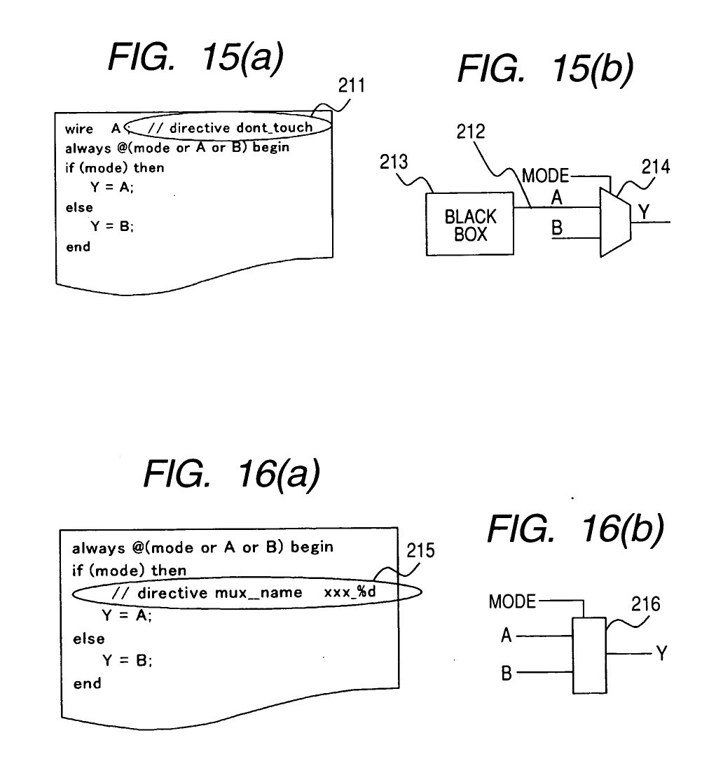

FIG. 15(a) is a diagram showing an example HDL description to which a wire logic optimization inhibition instruction is added. FIG. 15(b) is a diagram showing the logic structure of this HDL description. A synthesis instruction 211 in FIG. 15(a) designates, for a wire declared A, the inhibition of logic optimization. In FIG. 15(b), a signal 212 is a signal output by a black box 213, and is a logic selected in accordance with a control mode by a selector 214. In the logic optimization at step 117, for the thus designated wire A, logic is not inserted between the black box 213 and the selector 214. The wire logic optimization inhibition can be designated when, for example, a location selected in the test mode is detected relative to the signal that is output by the black box 213 based on the circuit structure analysis obtained at step 102.

FIG. 16(a) is a diagram showing an example HDL description for which an instance name instruction for a selector cell is provided, and FIG. 16(b) is a diagram showing the circuit structure of the HDL description. A synthesis instruction 215 in FIG. 16(a) designates the instance name of the selector cell generated by an if sentence. In FIG. 16(b), a selector 216 is this cell selector generated by an if sentence. In the logic optimization process at step 117, mapping is performed for the thus designated circuit structure to obtain a selector cell (a multiplexer) that employs a designated instance name. In this case, “_% d”, in the synthesis instruction 215, indicates the use of a bit value when a signal to be selected has a plurality of bits. A synthesis instruction for designating the instance name of the if sentence or the case sentence can be set when, for example, the if sentence or the case sentence that is controlled in the test mode is detected by the circuit structure analysis performed at step 102.

As described above, since the logic synthesis is performed while each synthesis instruction added HDL description is employed as input, the number of logic synthesis steps can be reduced during the large-scale collective synthesis processing.

Furthermore, since designation of the optimization priority level for individual modules and designation of an allocation inhibition cell are enabled as synthesis instructions, the optimal collective synthesis can be performed from the top level.

Further, since designation of the instance name of a selector and designation of an optimization inhibition net are also enabled as synthesis instructions, the setup of the constraint for the selector logic can be easily performed for the test circuit. Furthermore, a desired fault detection rate can be maintained.

(Fifth Embodiment)

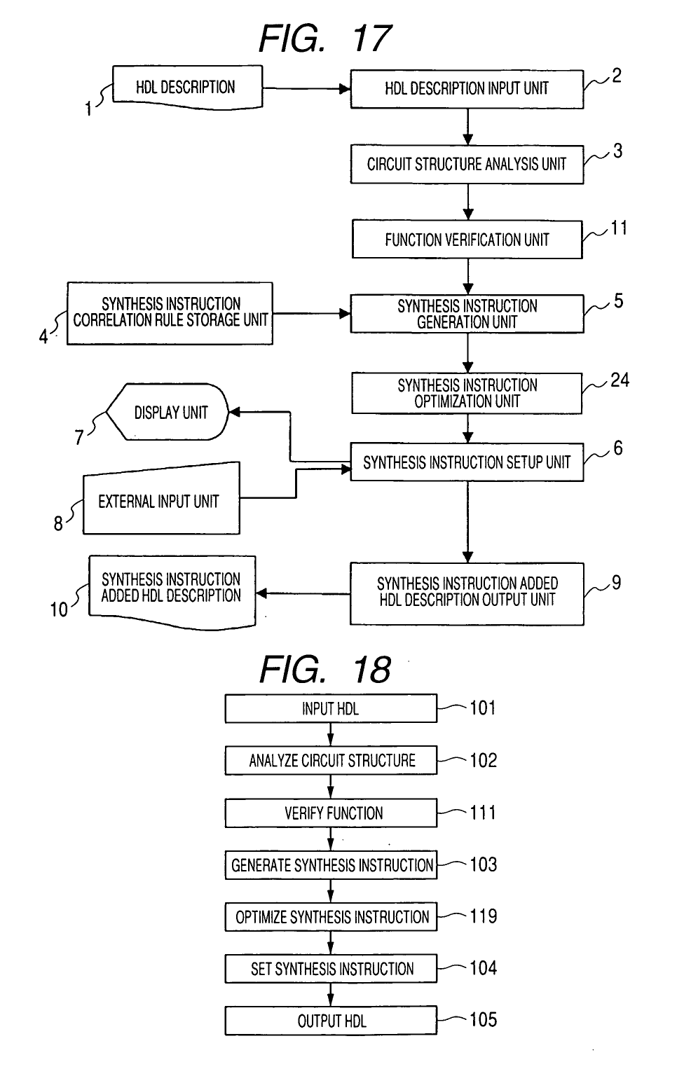

FIG. 17 is a block diagram showing the configuration of a logic circuit design support apparatus according to a fifth embodiment of the present invention, and FIG. 18 is a flowchart showing the logic circuit design support apparatus for this embodiment and a method therefor.

In FIG. 17, components 1 to 11 are the same as those shown in FIG. 7 for the second embodiment. The only difference from the configuration in FIG. 7 is that a synthesis instruction optimization unit 24 is additionally provided.

Similarly, in FIG. 18, the processes at steps 101 to 103 and at steps 104 and 105 are performed in the same manner as in FIG. 8 for the second embodiment.

When a synthesis instruction generation unit 5 has generated a synthesis instruction at step 103, at step 119, the synthesis instruction optimization unit 24 compares the synthesis instruction, generated at step 103, with a synthesis instruction obtained from an HDL description 1 entered at step 101. When the contents of the two synthesis instructions conflict, the synthesis instruction entered at step 101 is replaced by the new synthesis instruction generated at step 103. Thereafter, the processes at step 104 and the following steps are performed for all the synthesis instructions, including the replaced synthesis instruction.

As described above, the synthesis instruction optimization unit 24 has been provided, and is used to select an optimal synthesis instruction, from an synthesis instruction included in the HDL description 1 and a synthesis instruction generated by the synthesis instruction generation unit 5. Thus, when the synthesis instruction added HDL description that was previously generated is changed, or when alteration of a synthesis instruction is required because the specification for a logic synthesis tool that is employed is changed, the synthesis instruction can be easily changed to the optimal synthesis instruction.

The logic circuit design support apparatus and the logic circuit design support method of the invention include the synthesis instruction added HDL description output means, and are useful as an LSI design environment, which includes a logic synthesis process, and as the application of the IP.

What is claimed is:

1. A logic circuit design support apparatus, which employs an HDL description in which circuit information is written at a register transfer level (RTL), comprising:
an HDL description input unit, receiving a first HDL description;
a circuit structure analysis unit, analyzing types of function parts and connections of the function parts based on the circuit information;
a synthesis instruction generation unit, employing the analysis results to generate a synthesis instruction for a designated logic synthesis tool; and
a synthesis instruction added HDL description output unit, outputting a second HDL description obtained by adding the synthesis instruction to the first HDL description.

2. The logic circuit design support apparatus according to claim 1, further comprising:
a synthesis instruction correlation rule storage unit, storing a rule for correlating, with a characteristic of a circuit structure, a synthesis instruction method for a designated logic synthesis tool,
wherein the synthesis instruction generation unit refers to the synthesis instruction correlation rule.

3. The logic circuit design support apparatus according to claim 1, further comprising:
a display unit, displaying a synthesis instruction generated by the synthesis instruction generation unit;
an external input unit, manually, establishing an adoption of a synthesis instruction and additionally entering the synthesis instruction; and
a synthesis instruction setup unit, correlating the established synthesis instruction with a description location in the first HDL description.

4. The logic circuit design support apparatus according to claim 1, further comprising:
a synthesis instruction optimization unit, selecting an optimal synthesis instruction from either the synthesis instruction, written in the first HDL description, or the synthesis instruction, generated by the synthesis instruction generation unit.

5. The logic circuit design support apparatus according to claim 1, further comprising:
a function verification unit, for employing the circuit information to detect a false path for a circuit operation,
wherein the synthesis instruction added HDL description output unit outputs a second HDL description obtained by adding information for the false path to the first HDL description.

6. The logic circuit design support apparatus according to claim 1, further comprising:
a synthesis instruction input unit, for receiving a synthesis instruction, relative to the first HDL description, included in a logic synthesis tool execution script; and
a synthesis instruction allocation unit, for correlating the first HDL description with the synthesis instruction.

7. The logic circuit design support apparatus according to claim 1, further comprising:
an HDL description collective input unit, for receiving HDL description, for an entire logic circuit that is a logic synthesis target, that includes the second HDL description for each logic circuit generated by the synthesis instruction added HDL description output unit;
a synthesis instruction coupling unit, for coupling the logic circuit with the synthesis instruction;
a logic optimization unit for performing logic optimization for a predetermined logic library and a synthesis constraint, and generating a net list; and
a net list output unit, for outputting the net list.

8. A logic circuit design support method, for employing an HDL description in which is written circuit information at a register transfer level, comprising:
an HDL description input step of receiving a first HDL description;
a circuit structure analysis step of analyzing types of function parts and connections of the function parts based on the circuit information;
a synthesis instruction generation step of employing the analysis results to generate a synthesis instruction for a designated logic synthesis tool;
a synthesis instruction setup step of manually, establishing an adoption of a synthesis instruction and additionally entering the synthesis instruction, and of correlating the established synthesis instruction with a description location in the first HDL description; and
a synthesis instruction added HDL description output step of outputting a second HDL description obtained by adding the synthesis instruction to the first HDL description.

9. The logic circuit design support method according to claim 8, further comprising:
a synthesis instruction optimization step of selecting an optimal synthesis instruction from either the synthesis instruction, written in the first HDL description, or the synthesis instruction, generated at the synthesis instruction generation step.

10. The logic circuit design support method according to claim 8, further comprising:
a function verification step of employing the circuit information to detect a false path for a circuit operation, wherein the synthesis instruction added HDL description output step is a step of outputting a second HDL description obtained by adding information for the false path to the first HDL description.

11. The logic circuit design support method according to claim 8, further comprising:
a synthesis instruction input step of receiving a synthesis instruction, relative to the first HDL description, included in a logic synthesis tool execution script; and
a synthesis instruction allocation step of correlating the first HDL description with the synthesis instruction.

12. The logic circuit design support method according to claim 8, further comprising:
an HDL description collective input step of receiving HDL description, for an entire logic circuit that is a logic synthesis target, that includes the second HDL description for each logic circuit generated at the synthesis instruction added HDL description output step;
a synthesis instruction coupling step of coupling the logic circuit with the synthesis instruction;
a logic optimization step of performing logic optimization for a predetermined logic library and a synthesis constraint, and generating a net list; and
a net list output step of outputting the net list.

13. The logic circuit design support method according to claim 8, wherein the synthesis instruction added HDL description output step includes a step of outputting conditional branching of the HDL description employing a macro variable written in VerilogHDL.

14. The logic circuit design support method according to claim 8, wherein the synthesis instruction generation step includes the step of, when a conditional branch using a macro variable is included in the first HDL description, determining a macro variable value based on circuit structure analysis results; and wherein the synthesis instruction added HDL description output step includes a step of adding, to the second HDL description, a description for setting the value of the macro variable.

15. The logic circuit design support method according to claim 8, wherein the synthesis instruction added HDL description output step includes the steps of:
designating an output in an extensible language;
allocating a conversion rule extracted from a synthesis instruction for a description method in the extensible language; and
outputting a second HDL description in the extensible language.

16. The logic circuit design support method according to claim 8, wherein the HDL description includes:
a synthesis instruction relative to a module; and
a synthesis instruction relative to an instance that is a module at a lower level.

17. The logic circuit design support method according to claim 8, wherein logic synthesis is performed by employing an HDL description, in which circuit information is written at a register transfer level, and a logic library; and wherein designation of a cell for inhibiting an allocation in the logic library is enabled relative to individual modules in a logic hierarchy.

18. The logic circuit design support method according to claim 8, wherein, based on a plurality of evaluation values, logic synthesis is performed by employing an HDL description, in which circuit information at a register transfer level is written, and a logic library, and wherein priority ranks for the evaluation values are designated for individual modules in a logic hierarchy.

19. The logic circuit design support method according to claim 8, wherein logic synthesis is performed by employing an HDL description, in which circuit information at a register transfer level is written, and a logic library; and wherein a synthesis instruction added HDL description, which includes a logic optimization inhibition instruction relative to a wire-declared signal name, is output.

20. The logic circuit design support method according to claim 8, wherein logic synthesis is performed by employing an HDL description, in which circuit information is written at a register transfer level, and a logic library; and wherein a synthesis instruction added HDL description, which designates an instance name for of a selector cell relative to a case sentence or an if sentence, is output.
